(19) United States
(12) Patent Application Publication
(10) Pub. No.: US 2016/0042246 A1
(43) Pub. Date: Feb. 11, 2016

(54) A HAAR CALCULATION SYSTEM, AN IMAGE CLASSIFICATION SYSTEM, ASSOCIATED METHODS AND ASSOCIATED COMPUTER PROGRAM PRODUCTS

(71) Applicants: Stephan HERRMANN, Markt Schwaben (DE); Michael STAUDENMAIER, Munich (DE); Freescale Semiconductor, Inc, Austin, TX (US)

(72) Inventors: STEPHAN HERRMANN, MARKT SCHWABEN (DE); MICHAEL STAUDENMAIER, MUNICH (DE)

(73) Assignee: Freescale Semiconductor, Inc., Austin, TX (US)

(21) Appl. No.: 14/776,745

(22) PCT Filed: Mar. 22, 2013
(86) PCT No.: PCT/IB2013/052302

§ 371 Date: Sep. 15, 2015

(51) Int. Cl. G06K 9/46; B60R 1/00; G06T 7/20; G06T 7/00; G06K 9/00

(52) U.S. Cl. CPC G06K 9/4614; G06T 7/0081; G06K 9/00791; G06T 7/2033; B60R 1/00; G06T 2207/10016; B60R 2300/802; B60R 2300/8073

(57) ABSTRACT

A compute engine is arranged to retrieve a block of image data corresponding to a rectangular image region; calculate integral image values for all pixels of the block of image data to obtain an integral image of the block of image data; and store the integral image of the block in the one or more memories. The main processor determines which blocks of image data comprise pixels of the predefined rectangular region of the image, and defines a respective rectangular region part as the pixels of the block that belong to the predefined rectangular region of the image; calculate a HAAR feature of the rectangular region part for each block of image data that comprise pixels of the predefined rectangular region of the image; and add the HAAR features of the rectangular region parts to obtain the HAAR feature of the predefined rectangular region of the image.

### FIELD OF THE INVENTION

This invention relates to a HAAR calculation system, an image classification system, associated methods and associated computer program products.

### BACKGROUND OF THE INVENTION

Object detection and object recognition based on Haar features is often used. Haar features are the accumulated pixel values over a rectangular image region. Integral Images are used to pre compute values that can be used to easily compute the Haar features at dense image positions. An example is given in, e.g., international patent application WO 2007/128452 A2. WO 2007/128452 A2 describes methods and apparatus for operating on images, in particular for interest point detection and/or description working under different scales and with different rotations, e.g. for scale-invariant and rotation-invariant interest point detection and/or description. WO 2007/128452 A2 describes methods for matching interest points either in the same image or in a different image.

Massive parallel processing is used more and more often to process images, such as to perform pixel-based processing like color space conversion. However, as Integral Images have data dependencies from pixel to pixel and from line to line, known massive parallel architectures are not well apt to compute Integral Images and Haar features.

### SUMMARY OF THE INVENTION

The present invention provides a HAAR calculation system, an image classification system, a vehicle comprising a safety system, a method of calculating a HAAR feature of a predefined rectangular region of an image, a method of detecting an image feature in an image, a compute engine for a parallel processor system, a computer program product for calculating a HAAR feature, a computer program product for causing one or more compute engines of a parallel processor to calculate integral image values as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals.

FIG. 1 schematically shows an example of an embodiment of a system comprising a HAAR calculation system;

FIG. 2 schematically shows a partitioning of an image into image blocks and an allocation of image blocks to compute engines for parallel processing;

FIG. 3a-FIG. 3c schematically show scanning schemes within image blocks of an image;

FIG. 4 schematically illustrates a known method of calculating a HAAR feature;

FIG. 5 schematically shows a known method of calculating a HAAR feature using a SIMD parallel computing architecture;

FIG. 6 and FIG. 7 schematically illustrate a method of calculating a HAAR feature according to an embodiment;

FIG. 8 and FIG. 9 schematically illustrate methods of calculating a HAAR feature according to embodiments;

FIG. 10a and FIG. 10b schematically illustrate methods of calculating a HAAR feature according to further embodiments;

FIG. 11 schematically shows an exemplary user interaction system;

FIG. 12 schematically shows a vehicle comprising a safety system;

FIG. 13 shows a computer readable medium comprising a computer program product; and

FIG. 14 shows another computer readable medium comprising another computer program product.

### DETAILED DESCRIPTION OF THE PREFERRED EMBODIMENTS

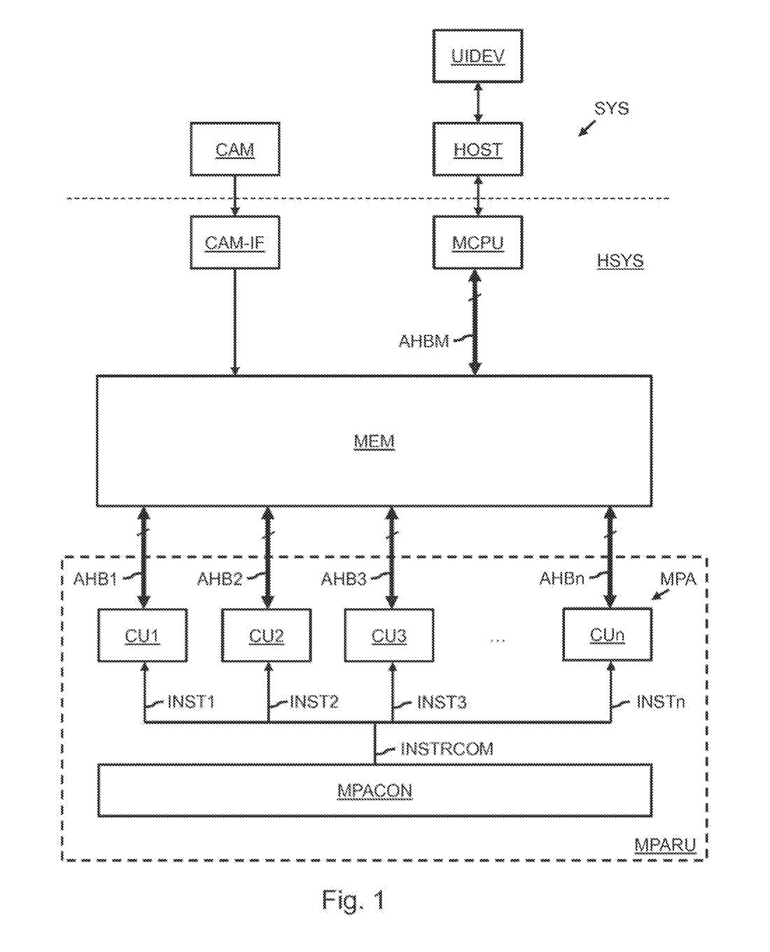

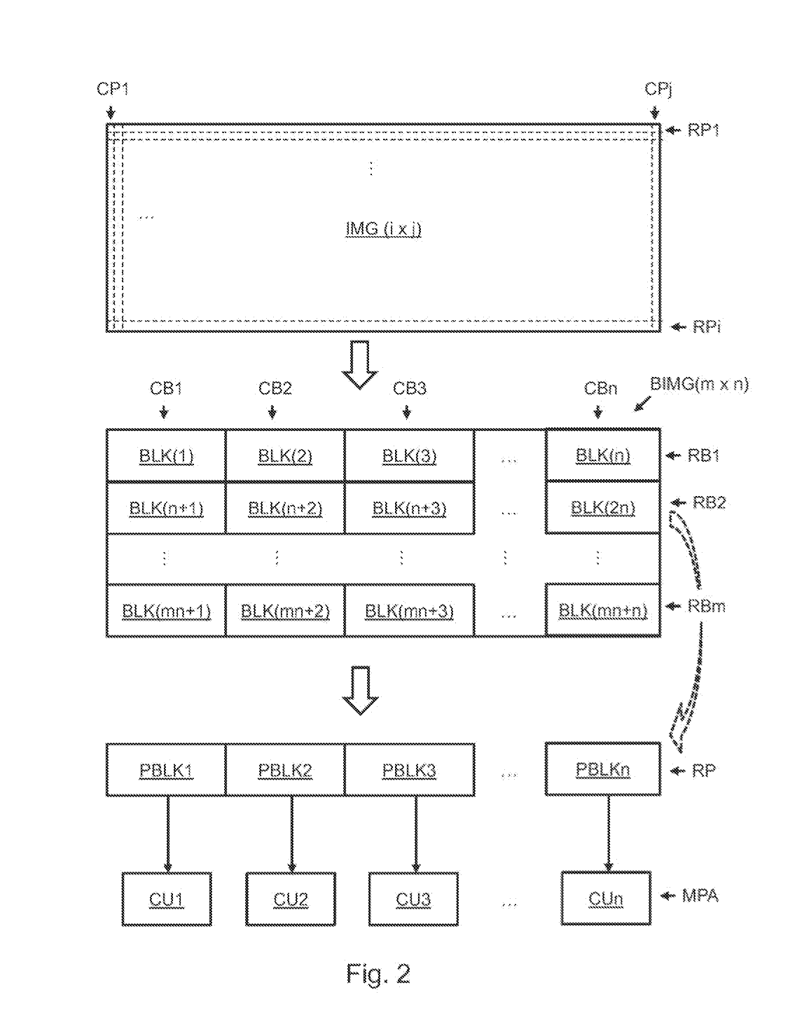

FIG. 1 schematically shows an example of an embodiment of a system SYS comprising a camera CAM, a HAAR calculation system HSYS, a host processor HOST and a user interface device UIDEV. The HAAR calculation system HSYS comprises a camera interface CAM-IF, a memory MEM, a massive parallel processor unit MPARU and a main processor MCPU. The camera interface CAM IF is connectable to the camera CAM and arranged to receive image data from the camera CAM and to store the image data in the memory MEM. Each image comprises image data of a rectangular array of pixels as indicated in FIG. 2: an image IMG (i×j), or IMG in short, comprises a plurality of i pixel rows, with row numbers RP1, . . . , RPi, and a plurality of j pixel columns, with column numbers CP1, . . . , CPj. Each image IMG(i×j) is stored in the memory MEM. The MEM may comprise a DDR memory. The massive parallel processor unit MPARU comprises an array MPA of a plurality of compute engines CU1, CU2, CU3, . . . , CUn. FIG. 1 shows that the array MPA comprises at least 4 compute engines, but alternative embodiments may use less compute engines, such as two, and other alternative embodiments may use more compute engines, such as 8, 16, 32, 64, 128, or another suitable number.

The plurality of compute engines may be two compute engines CU1, CU2. In alternative embodiments, the plurality of compute engines may comprise 4, 8 or more, such as at least 16 compute engines, such as 32 compute engines, 64 compute engines, or 128 compute engines or another number of compute engines equal to a power of two, or different from a power of two

The plurality of compute engines CU1, . . . , CUn may be arranged to be executed with common instructions. E.g., the compute engines CU1, . . . , CUn may be arranged in a socalled single-instruction-multiple-data (SIMD) arrangement. The plurality of compute engines CU1, CU2, CU3, . . . CUn may be arranged and operable as a single program, multiple data (SPMD)-type architecture, wherein the plurality of compute engines CU1, CU2, CU3, . . . CU are arranged to perform calculations on respective blocks of image data in parallel, by performing substantially the same program on the different blocks. When operated in a Single Program Multiple Data (SPMD) architecture, tasks may be split up and run simultaneously on multiple compute engines with different input, such as different blocks of image data. For example, the compute engines may run the same code on different data in parallel. Further architectures may e.g., have groups of compute engines running substantially the same instruction flow, with each of the compute engines taking his own path of any branches in the instruction flow, such as different branches in if/then/else construct or different branches depending on, for example, a counter or an index of a block.

The plurality of compute engines CU1, CU2, CU3, . . . CUn are arranged to access the memory MEM via respective busses AHB1, AGB2, AHB3, . . . , AHBn. The plurality of compute engines CU1, CU2, CU3, . . . CUn may be arranged to read from and to write to the memory MEM. The memory MEM may be a single memory, or may comprise more than one memories. If the memory comprises more than one memories, the plurality of compute engines CU1, CU2, CU3, . . . CUn may be arranged to read from one memory and to write to the another memory of the more than one memories MEM. The main processor MCPU is arranged to access the memory via bus AHBM, and is arranged to at least read data from the memory MEM, such as to read data that were written into the memory MEM by the compute engines CU1, CU2, CU3, . . . CUn.

The array MPA having the plurality of compute engines CU1, CU2, CU3, . . . CUn is connected to an array controller MPACON. The array controller MPACON is arranged to control the plurality of compute engines CU1, CU2, CU3, . . . CUn via control connections INST1, INST2, INST3, . . . , INSTn, which may—as shown in FIG. 1—be derived from a common control connection INSTCOM. In an embodiment, the array controller MPACON may be arranged to provide instructions and a clock to the compute engines CU1, CU2, CU3, . . . CUn via the common control connection INSTCOM and the respective control connections INST1, INST2, INST3, . . . , INSTn. In an alternative embodiment, the array controller MPACON may be arranged to provide a clock to the compute engines CU1, CU2, CU3, . . . CUn via the common control connection INSTCOM and the respective control connections INST1, INST2, INST3, . . . , INSTn, and the compute engines CU1, CU2, CU3, . . . CUn are arranged to fetch instructions from the memory MEM in dependence on the clock provided by the array controller MPACON.

In order to let the plurality of compute engines CU1, CU2, CU3, . . . CU perform calculations on respective blocks of image data in parallel, the image IMG (i×j) may be considered as an array of blocks of image data, as will be described with reference to FIG. 2. The an IMG (i×j) comprising the plurality of i pixel rows, with row numbers RP1, . . . , RPi, and the plurality of j pixel columns, with column numbers CP1, . . . , CPj, may be considered to be a block array BIMG (m×n) of a plurality of m rows of blocks, with block row numbers RB1, RB2, . . . , RBm and a plurality of n columns of blocks, with block column numbers CB1, CB2, CB3, . . . , CBn. The plurality of blocks may thus be labelled and numbered as BLK(1), BLK(2), BLK(3), . . . , BLK(n), BLK(n+1), BLK(n+2), BLK(n+3), . . . , BLK(2n), . . . , BLK(mn+1), BLK(mn+2), BLKM(mn+3), . . . , BLK(mn+n). The blocks may further be referred to as image blocks.

FIG. 2 schematically shows a partitioning of an image into image blocks and an allocation of image blocks to compute engines for parallel processing. In an embodiment, shown in FIG. 2, the number of blocks per row of blocks, n, is equal to the number of compute engines CU1, CU2, . . . , CUn, but in alternative embodiments, the number of blocks of compute engines may be different from the number of blocks per row of blocks. In the following, a non-limiting embodiment is described wherein the number of compute engines is equal to the number of blocks per row of blocks will be described. The skilled person will appreciate how alternative embodiments may be designed wherein the number is different.

As FIG. 2 shows, a plurality of blocks of image data may be processed in parallel by a respective plurality of computer engines. The plurality of compute engines CU1, CU2, CU3, . . . , CUn may for example be arranged to processes one row of blocks at a time, and, after having processed one row, continue to process the next row. This is indicated by the dashed double arrow in FIG. 2, which shows a snapshot of the system: row block RB2 comprising blocks BLK(n+1), . . . , BLK(2n) is used as a processing row block EP of n processing blocks PBLK1, PBLK2, PBLK3, . . . , PBLKn, to be processed by the respective compute engines CU1, CU2, CU3, . . . , CUn.

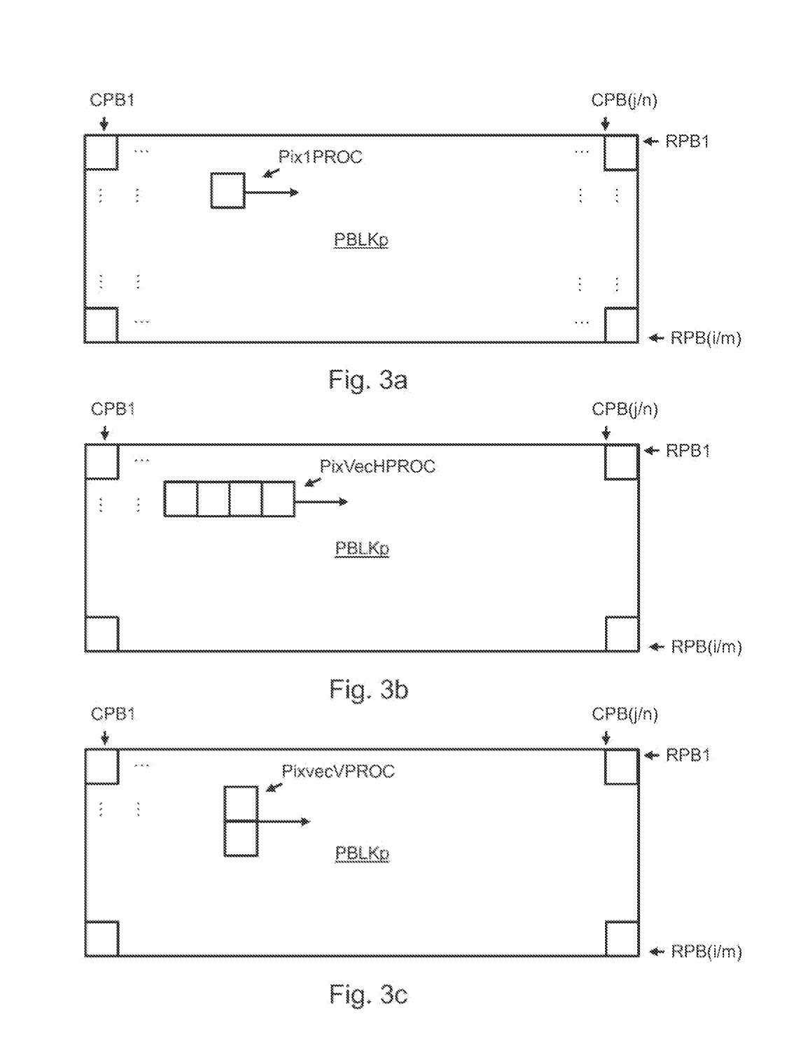

When a compute engines CUp processes image block PBLKp, the compute engine scans all pixels of the image block to retrieve the pixel data value of the pixel block and to perform a calculation, such as a summation, of the pixel data. Hereto, the compute engines CUp may be arranged to use one of a plurality of possible scanning schemes. Further, the compute engines CUp may be scalar processors arranged to process one pixel at a time, or vector processors arranged to process a plurality of pixels at a time, such as a plurality of horizontal neighbours or a plurality if vertical neighbours. FIG. 3a-FIG. 3c schematically show some of possible scanning schemes within image blocks of an image. The skilled person will appreciate that more scanning schemes are possible and may be used in further embodiments. For example, scanning schemes may be so-called horizontal scanning schemes, where scanning is performed row-by-row from the start of a respective row to the end of the row, or so-called vertical scanning schemes, where scanning is performed along column-by-column from the start of a respective column to the end of the column.

FIG. 3a shows a horizontal scanning scheme wherein the compute engine CUp comprises a scalar single-pixel processor core for processing a single pixel Pix1PROC at a time. After the pixel Pix1PROC is processed, the compute engines CUp moves to the horizontally adjacent pixel until the last pixel of the block on this row, i.e., from pixel column CPB1 to pixel column CPB(j/n) within the block: then, compute engines CUp continues to process the first pixel of the next row, until all rows RPB1, . . . , RPM (i/m) of block PBLKp have been processed.

FIG. 3b shows a horizontal scanning scheme wherein the compute engine CUp comprises a vector processor core arranged to process a plurality of horizontally adjacent pixels PixvecHPROC at a time, i.e., pixels on the same row but of adjacent columns. After completion of the processing of plurality of the horizontally adjacent pixels PixvecHPROC, the compute engines CUp moves to the next plurality of horizontally adjacent pixels.

FIG. 3c shows a horizontal scanning scheme wherein the compute engine CUp comprises a vector processor core arranged to process a plurality of vertically adjacent pixels PixvecVPROC at a time, i.e., pixels on adjacent rows within one column. After completion of the processing of plurality of the vertically adjacent pixels PixvecVPROC, the compute engines CUp moves to the next column to process a next plurality of vertically adjacent pixels.

Each compute engine of the plurality of compute engines CU1, CU2, CU3, CUn may thus comprise, or be, a vector processor, arranged to simultaneously process a plurality of pixels.

The different scanning schemes within the blocks may be used in different embodiments of the invention.

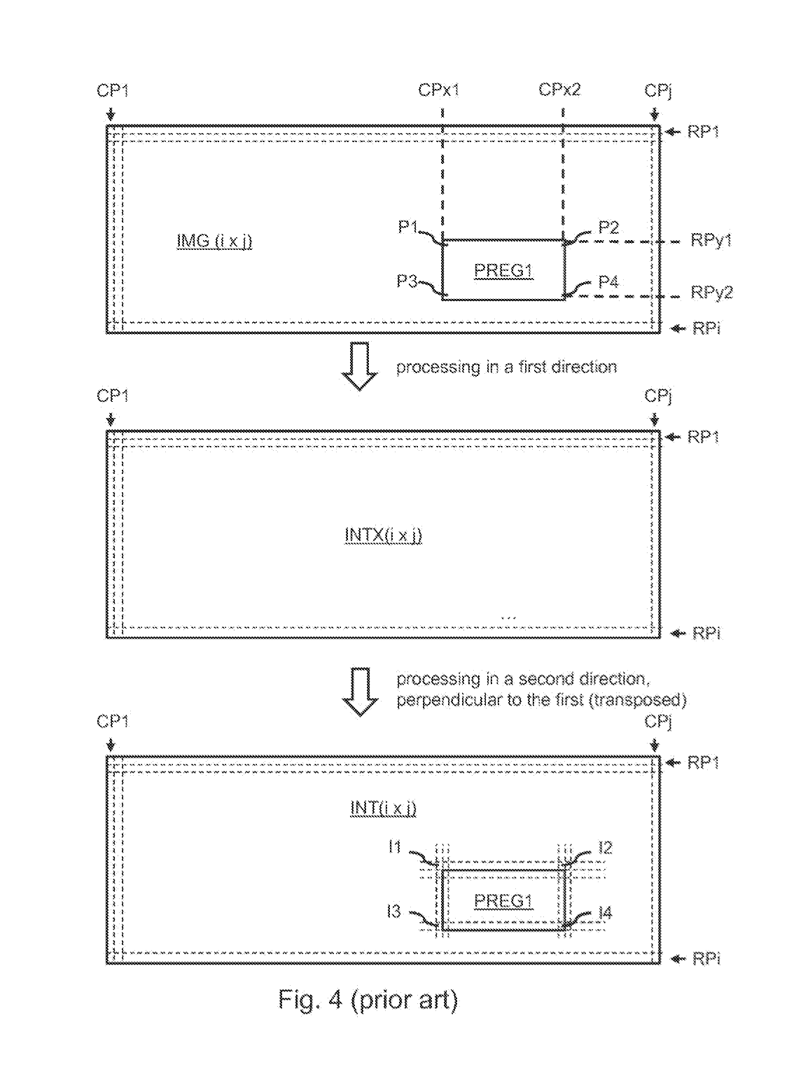

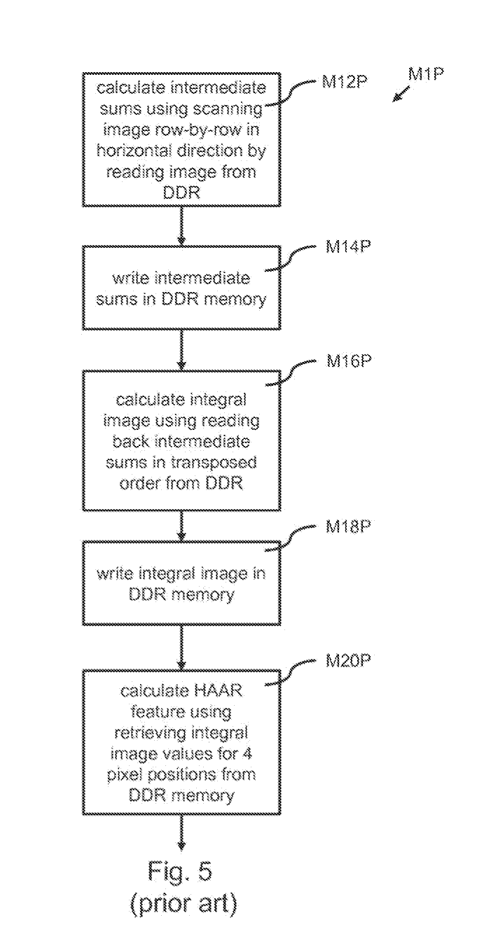

FIG. 4 and FIG. 5 schematically illustrates a known method of calculating a HAAR feature of a predefined rectangular region PREG1 of an image IMG (i×j) of a plurality of pixels P(x,y) with pixel values IMG(x,y) in a two-dimensional pixel array of i pixel rows RP1, . . . , RPi and j pixel columns CP1, . . . , CPj. The predefined rectangular region PREG1 is limited by pixel columns CPx1 and CPx2 and pixel rows RPy1 and RPy2 and may be indicated by its corner pixels: an upper left corner pixel P1=(CPx1, RPy1), an upper right corner pixel P2=(CPx2, RPy1), a lower left corner pixel P3=(CPx1, RPy2) and a lower right corner pixel P4=(CPx2, RPy2), i.e., with upper left and right corner pixels on pixel row RPy1 and pixel columns CPx1 and CPx2 respectively, and lower left and right corner pixels on pixel row RPy2 and pixel columns CPx1 and CPx2 respectively. Hereto, the known method first calculates an integral image, the integral image for each pixel P=(x, y) being defined as:

INT(x,y)=IMG(x,y)+INT(x−1,y)+INT(x,y−1)−INT(x−1,y−1)

with x running horizontally and y running vertically.
The HAAR feature for region PREG1 limited by pixel columns CPx1 and CPx2 and pixel rows RPy1 and RPy2 with corner pixels P1, P2, P3, P4 is then defined as:

HAAR(CPx1,RPy1,CPx2,RPy2)=INT(CPx2,RPy2)−INT(CPx2,RPy1-1)−INT(CPx1-1,RPy2)+INT(CPx1-1,RPy1-1),

which we may schematically indicated as

HAAR(PREG2)=I4−I2−I3+I1

with I1, I2, I3 and I4 schematically indicating the integral image terms of the above expression, i.e.:

I1=INT(CPx1-1, RPy1-1),

I2=INT(CPx2, RPy1-1),

I3=INT(CPx1-1, RPy2),

I4=INT(CPx2, RPy2).

I1, I2, I3 and I4 thus correspond to the integral image values of pixel positions associated with the corner pixels: (CPx1-1, RPy1-1) associated with corner pixel P1, (CPx2, RPy1-1) associated with corner pixel P2, (CPx1-1, RPy2) associated with corner pixel P3 and (CPx2, RPy2) associated with corner pixel P4. This is schematically indicated in the bottom figure of FIG. 4 with I1-I4 reference signs referring to the respective associated pixel positions.

In order to calculate the HAAR feature of the rectangular region PREG1, the known method first scans the whole image IMG (i×j) in a first scanning direction, for example horizontally in the x-direction, to obtain intermediate results which correspond to the integral in the first (here, horizontal) direction, INTX(i×j). This first scanning may be expressed in a vector-like notation as:

INTX((x,y1),(x,y2),(x,y3), . . . ,(x,yn))=IMG((x,y1),(x,y2),(x,y3), . . . ,(x,yn))+INTX((x−1,y1),(x−1,y2),(x−1,y3), . . . ,(x−1,yn)).

Then, the known method uses a second scan, in a second scanning direction over the intermediate results to determine the integral image from the intermediate results. The second scanning direction is vertically if the first scanning direction is horizontally. This second scanning may be expressed in a vector-like notation as:

INT((x1,y),(x2,y),(x3,y), . . . ,(xn,y))=INTX((x1,y),(x2,y),(x3,y), . . . ,(xn,y))+INT((x1,y−1),(x2,y−1),(x3,y−1), . . . ,(xn,y−1)).

i.e., the integral image values are obtained from a first scanning in the horizontal x-direction to obtain integrals over pixel values along the x-direction as the intermediate results, followed by a second scanning in the vertical y-direction to obtain the integral image from the intermediate results.

If implemented using a plurality of compute engines with parallel processing, the implementation M1P of the known method thus comprises, as shown in FIG. 5, calculating M12P intermediate sums from scanning the image IMG row-by-row in a horizontal scanning direction from reading image values from the memory, for example a DDR memory, and writing M14P the intermediate sums as calculated in the memory. Next, the known method comprises calculating M16P an integral image values from reading back intermediate sums in a transposed order (i.e., in a vertical scanning direction) from the memory, and writing the integral image values in the memory. Next, the known method comprises calculating M20P a HAAR feature from reading the integral image values from four pixel positions from the memory. Writing back the intermediate results into and reading back the intermediate results from the memory may require a significant amount of bandwidth. This may be a hurdle of using a large-capacity memory (as required by image size and amount of information—i.e., the image, the intermediate values and the integral image—to be stored) of a relatively low cost, as such large-capacity memory typically need to be separate devices, such as a DDR memory, and have a practical upper limit to the bandwidth supported within a certain cost range. There may thus be a wish to provide an improved method and system.

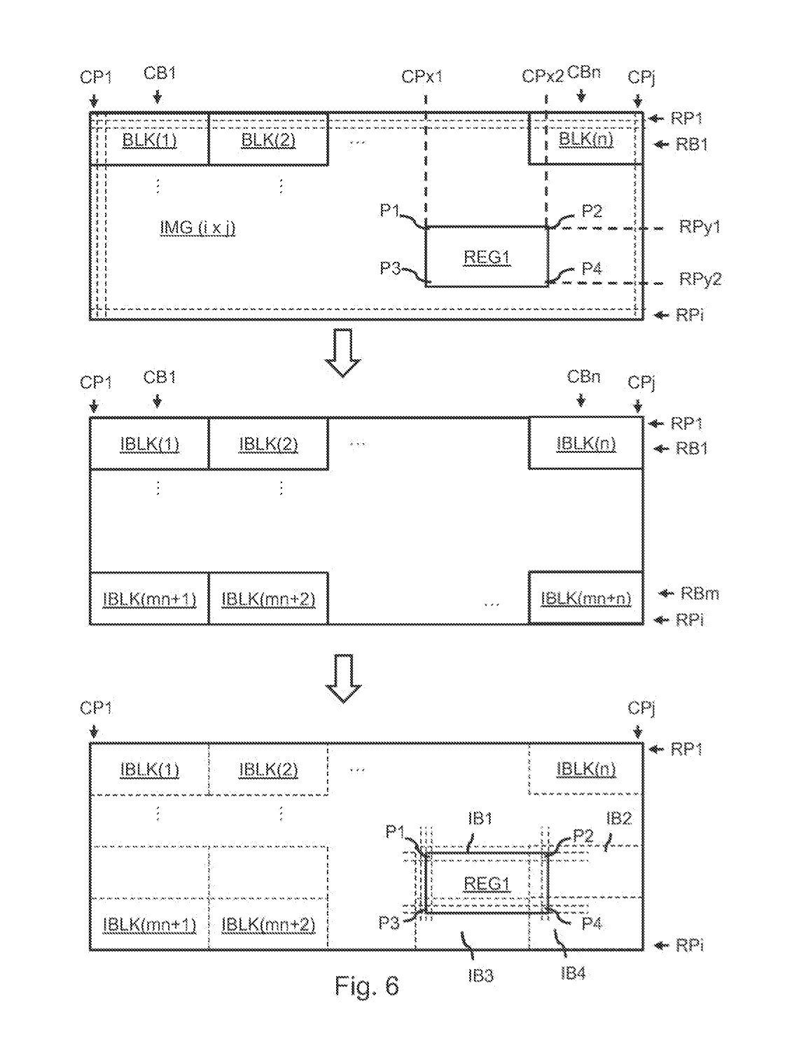

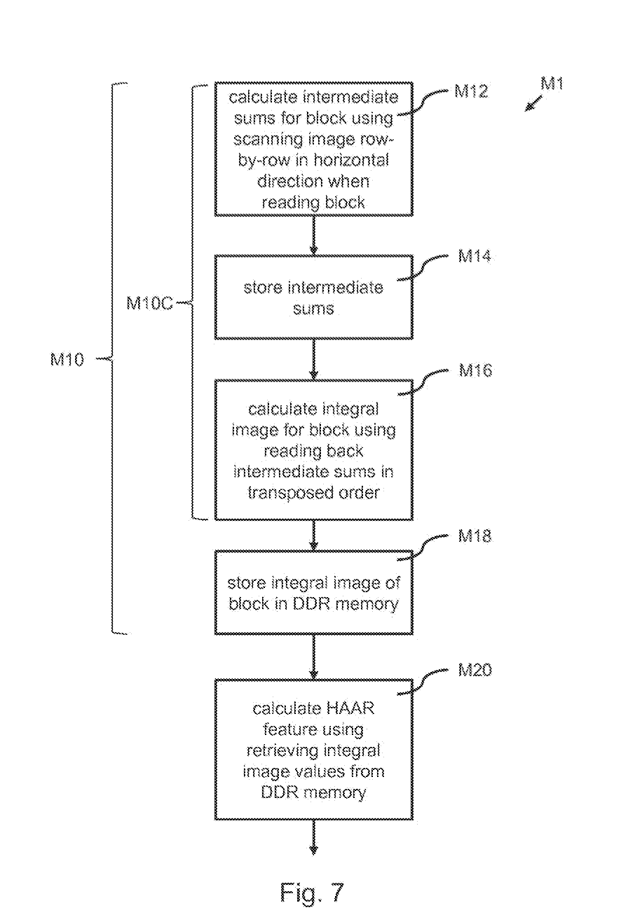

FIG. 6 and FIG. 7 schematically illustrate a method of calculating a HAAR feature according to an embodiment. The method calculates a HAAR feature of a predefined rectangular region REG1 (for clarity indicated with a different reference number as the predefined rectangular region PREG1 in the known example described above) of an image IMG (i×j) of a two-dimensional pixel array of i pixel rows RP1, . . . , RPi and j pixel columns CP1, . . . , CPj. The predefined rectangular region REG1 is limited by pixel columns CPx1 and CPx2 and pixel row RPy1 and RPy2 and may be indicated by its corner pixels: an upper left corner pixel P1=(CPx1, RPy1), an upper right corner pixel P2=(CPx2, RPy1), a lower left corner pixel P3=(CPx1, RPy2) and a lower right corner pixel P4=(CPx2, RPy2), i.e., with upper left and right corner pixels on pixel row RPy1 and pixel columns CPx1 and CPx2 respectively, and lower left and right corner pixels on pixel row RPy2 and pixel columns CPx1 and CPx2 respectively.

The method uses a division of the image data IMG(i×j) in a plurality of m×n blocks of image data corresponding to respective rectangular image regions BLK(1), BLK(1, . . . , mn+n), organized in a two-dimensional array of m rows RB1, . . . , RBm of blocks of image data and n columns CB1, . . . , CBn of blocks of image data. In the following a block of image data and the corresponding rectangular image region may be referred to with the same reference sign BLK(k), k=1, . . . , mn+n, as it will be clear to the skilled person what is referred to and different reference signs for the two entities may only obscure the description of the method and system. Each block of rectangular image regions BLK(1), . . . , BLK(1, . . . , mn+n) may also be referred to as a “tile” to indicate that the blocks together “tile up” to the complete image.

The method may be performed using a HAAR calculation system HSYS shown in FIG. 1, comprising one or more memories MEM for storing data including an image data,—a plurality of (two or more) compute engines CU1, CU2, CU3, CUn and a main processor MCPU.

The method comprises calculating M10C integral images per block of image data and storing M18 the integral images per block of image data in the one or more memories MEM. Hereto, each of the compute engines is arranged to retrieve a block of image data BLK(i) corresponding to a rectangular image region BLK(1) . . . (BLK(mn+n) from the one or more memories MEM, calculate integral image values IBLK(i) for all pixels of the block of image data to obtain an integral image of the block of image data, and store the integral image IBLK(i) of the block in the one or more memories MEM. Hereby, a plurality of integral images IBLK(1), . . . , IBLK(mn+n) is obtained: one integral image per block of image data. The plurality of integral images of blocks may together be referred to as “tiled integral image”, indicating that the integral image is not a single integral image as in the prior art, but comprising multiple integral images, one per block, which may be considered as together forming a tiled integral image. The integral image values for pixels of a block of image data may further also be referred to as block-wise integral values.

For calculating the integral image values IBLK(i) for all pixels of the block of image data to obtain an integral image of the block of image data, the respective compute engine may be arranged to calculate M12 intermediate results for the block of image data using a row-by-row scan over the block of image data in horizontal direction to read the block of image data from the one or more memories, to store M14 the intermediate results in the one or more memories or in a local memory of the compute engine, and to calculate M16 the integral image for the image block using a reading of the intermediate results in transposed order from the one or more memories or from the local memory. The compute engine may perform these actions in a similar manner as the calculation of the integral image in the prior art, which used a horizontal and a vertical scanning and an intermediate result written to and read from the one or more memories. However, using intermediate results per block does not require storing intermediate results for i×j pixels in an external DDR memory, as in the prior art, but may only require storing the intermediate results for the number of blocks being processed in parallel, i.e., corresponding to the number of compute engines. This may impose lower bandwidth requirements to the external DDR if an external DDR is used to store the intermediate results. Further, this may allow to use a local memory per compute engine, which may be an integrated memory (“on-chip”) or a local external memory. The local external memory may be of a relatively small size compared to the DDR memory that would be required in the prior art and/or may have much lower bandwidth requirements and/or may have a lower cost.

The method may thus obtain the tiled integral image as a plurality of integral images IBLK(1), IBLK(2), . . . , IBLK(n), . . . , IBLK(mn+1), IBLK(mn+2), . . . , IBLK(mn+n), one for each block of image data. The plurality of integral images IBLK(1), IBLK(2), . . . , IBLK(n), . . . , IBLK(mn+1), IBLK(mn+2), . . . , IBLK(mn+n) may further be referred to as “block-wise integral images” or as “integral image tiles”.

The method further comprises calculating M20 the HAAR feature from retrieving integral image values from the one or more memories MEM and calculating the HAAR feature from the integral image values as retrieved.

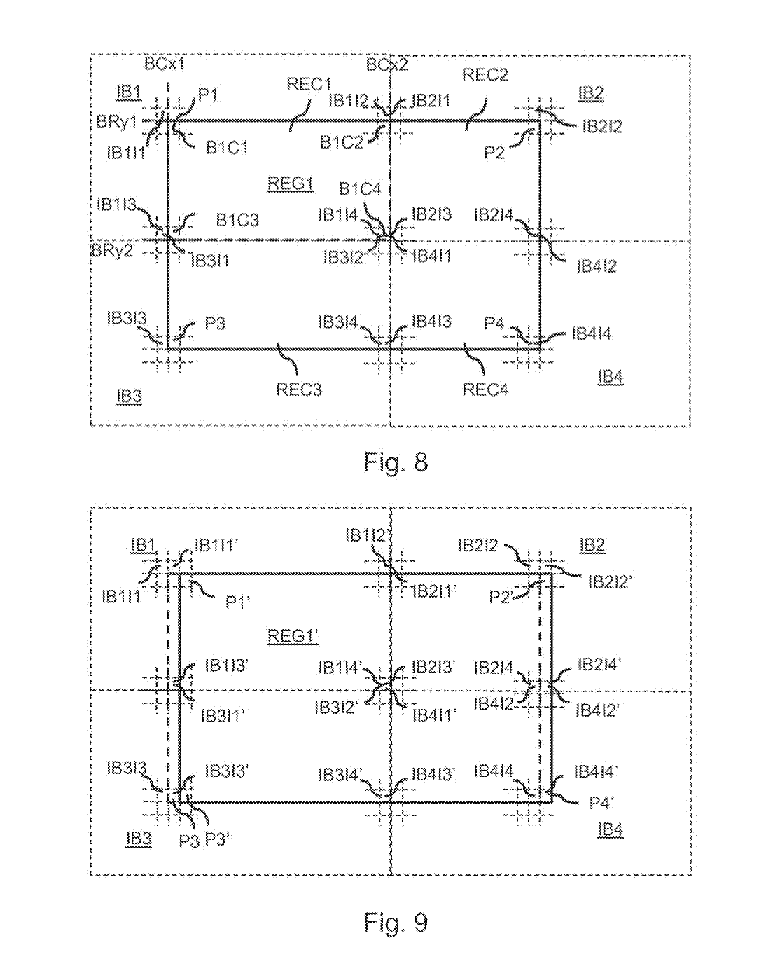

Hereto, in an embodiment, the main processor MCPU may be arranged to determine which one or more blocks of image data IB1, IB2, IB3, IB4 comprise pixels of the predefined rectangular region REG1 of the image. A first example is shown in the bottom figure of FIG. 6 and FIG. 8. FIG. 6 shows that the predefined rectangular region REG1 consists of pixels corresponding to four integral image tiles, each integral image tile comprising one of the corner pixels P1, P2, P3 or P4: integral image tile IBLK((m−1)n+(n−1)), labelled as image block IB1, integral image tiles IBLK((m−1)n+n), labelled as IB2, integral image tile IBLK(mn+(n−1)), labelled as image block IB3, integral image tiles IBLK(mn+n), labelled as IB4. Blocks comprising a corner pixel P1, P2, P3 or P4 may further be referred to as “corner blocks” IB1, IB2, IB3, IB4.

In a further embodiment, the main processor MCPU may further be arranged to, for each block of image data IB1, IB2, IB3, IB4 that comprise pixels of the predefined rectangular region of the image, define a respective rectangular region part REC1, REC2, REC3, REC4 as the pixels of the block that belong to the predefined rectangular region REG1 of the image. This is illustrated in FIG. 8 for the first example, where four rectangular regions REC1, REC2, REC3 and REC4 together correspond to the predefined rectangular region REG1 of the image. The first rectangular region REC1 in the pixel block corresponding to image block IB1 extends from upper left pixel P1 to adjacent rectangular blocks REC2, REC3, REC4. The second rectangular region REC2 in the pixel block corresponding to image block IB2 extends from upper right pixel P2 to adjacent rectangular blocks REC1, REC3, REC4. The third rectangular region REC3 in the pixel block corresponding to image block IB3 extends from lower left pixel P3 to adjacent rectangular blocks REC1, REC2, REC4. The fourth rectangular region REC4 in the pixel block corresponding to image block IB4 extends from lower right pixel P4 to adjacent rectangular blocks REC1, REC2, REC3. The rectangular regions associated with corner blocks IB1, IB2, IB3, IB4 may further be referred to as corner regions REC1, REC2, REC3, REC4.

In another embodiment, one or more compute engines of the plurality of compute engines CU1, CU2, CU3, . . . CU may be arranged to act as main processor. In this another embodiment, the one or more compute engines of the plurality of compute engines CU1, CU2, CU3, . . . CU arranged to act as main processor may be arranged to determine which one or more blocks of image data IB1, IB2, IB3, IB4 comprise pixels of the predefined rectangular region REG1 of the image. In an alternative further embodiment, the one or more compute engines of the plurality of compute engines CU1, CU2, CU3, . . . CU arranged to act as the main processor may further be arranged to, for each block of image data IB1, IB2, IB3, IB4 that comprise pixels of the predefined rectangular region of the image, define a respective rectangular region part REC1, REC2, REC3, REC4 as the pixels of the block that belong to the predefined rectangular region REG1 of the image.

The main processor MCPU may further be arranged to calculate HAAR features of respective rectangular region parts REC1, REC2, REC3, REC4 for each block of image data IB1, IB2, IB3, IB4 that comprises pixels of the predefined rectangular region REG1 of the image, and add the HAAR features of the rectangular region parts REC1, REC2, REC3, REC4 to obtain the HAAR feature of the predefined rectangular region of the image.

Hereto, the main processor MCPU may be arranged to, for each block of image data IB1, IB2, IB3, IB4 that comprise pixels of the predefined rectangular region REG1 of the image: retrieve integral image values IB1I1, IB1I2, IB1I3, IB1I4 associated with the corner pixels B1C1, B1C2, B1C3, B1C4 of the respective rectangular region part REC1 from the one or more memories MEM, and calculate the HAAR feature of the rectangular region part REC1 for the block from the integral image values associated with the corner pixels B1C1, B1C2, B1C3, B1C4 of the respective rectangular region part REC1, so as to calculate the HAAR features of the rectangular region parts REC1, REC2, REC3, REC4, REC12, REC34 for all blocks of image data that comprise pixels of the predefined rectangular region of the image.

The compute engines may be arranged to calculate the integral image values at a bit depth in a range of 1.5-3 times a pixel bit depth, such as 2 times the pixel bit depth, wherein the pixel bit depth correspond to a bit depth in which the image data is represented. Hereby, the compute engines may be simplified and/or the bandwidth requirements associated with storing integral image data in the one or more memories may be reduced compared to prior art systems wherein prior art compute engines need to calculate an integral image of the complete image which a significantly larger bit depth requirements (typically, 32 bits for an integral image from 8-bit pixel values) as the relatively relaxed requirements for compute engines in embodiments, which only need to process one block of image data at a time.

For example, for the first example as illustrated by FIG. 8, the main processor MCPU may calculate HAAR features for rectangular region parts REC1, REC2, REC3 and REC4 from the respective corner pixels P1, P2, P3, P4 and pixels at the other corners of the respective rectangular region. Hereto, the main processor may be arranged to, in determining which one or more blocks of image data comprise pixels of the predefined rectangular region of the image, determine one or more corner blocks IB1, IB2, IB3, IB4 from identifying which one or more blocks of the one or more blocks of image data comprise a corner pixel P1, P2, P3, P4 of the predefined rectangular region of the image.

For example, the HAAR feature of rectangular region REC1 may be calculated from the block-wise integral image values IB1I1, IB1I2, IB1I3 and IB1I4 associated with, respectively, the upper left block corner pixel P1 (also referred to as B1C1 in the Figure, indicating Block 1 Corner pixel 1), the upper right block corner pixel B1C2, the lower left block corner pixel B1C3 and the lower right block corner pixel B1C4, as

HAAR(REC1)=INT_{—}IB1(BCx2,BRy2)−INT_{—}IB1(BCx2,BRy1-1)−INT_{—}IB1(BCx1-1,BRy2)+INT_{—}IB1(BCx1-1,BRy1-1),

wherein INT_IB1 denotes the integral image for block IB1, which may schematically be written as:

HAAR(REC1)=IB1I4−IB1I2−IB1I3+IB1I1,

wherein IB1I1 denotes INT_IB1(BCx1-1, BRy1-1) which represents the block-wise integral value at the top left neighbour position of B1C1, IB1I2 denotes INT_IB1(BCx2,BRy1-1) which represents the block-wise integral value at the top neighbouring position of B1C2, IB1I3 denotes INT_IB1(BCx1-1,BRy2) which represents the block-wise integral value at the left neighbouring position of B1C3 and IB1I4 denotes INT_IB1(BCx2,BRy2) which represents the block integral value at the position of B1C4.

The HAAR feature for rectangular region REG1 may thus be calculated from the block-wise integral images values associated with all corner pixels of the rectangular regions REC1, REC2, REC3, REC4 as:

$$\begin{matrix}HAAR ( REG 1 ) = HAAR ( REC 1 ) + HAAR ( REC 2 ) + HAAR ( REC 3 ) + \\ HAAR ( REC 4 ) \\ = IB 1 I 4 = IB 1 I 2 - IB 1 I 3 + IB 1 I 1 + \\ IB 2 I 4 - IB 2 I 2 - IB 2 I 3 + IB 2 I 1 + \\ IB 3 I 4 - IB 3 I 2 - IB 3 I 3 + IB 3 I 1 + \\ IB 4 I 4 - IB 4 I 2 - IB 4 I 3 + IB 4 I 1\end{matrix}$$

Herein, IB2I3, IB2I1, IB3I2, IB3I1, IB4I2, IB4I3, and IB4I1 relate to pixels outside of their blocks, so that their block-wise integral image values are 0. The formula may thus be simplified to:

HAAR(REG1)=IB1I4−IB1I2−IB1I3+IB1I1+IB2I4−IB2I2+IB3I4−IB3I3+IB4I4.

Herein, the main processor MCPU may be required to read just 9 values from the one or more memories.

The main processor may thus be arranged to, for each of the one or more corner blocks IB1, IB2, IB3, IB4, retrieve the block-wise integral image values IB1I1, IB1I2, IB1I3, IB1I4 associated with corner pixels B1C1, B1C2, B1C3, B1C4 of the rectangular region part in the corner block IB1, from the one or more memories, and calculate the HAAR feature of the rectangular region part REC1 of the corner block IB1 using the block-wise integral image values IB1I1, IB1I2, IB1I3, IB1I4 associated with the corner pixels B1C1, B1C2, B1C3, B1C4 of the rectangular region part in the corner block IB1.

In a further embodiment, the number of values to be read by the main processor MCPU may further be reduced during a further calculation of a HAAR feature of a shifted rectangular region REG1′ to obtain HAAR-features of the rectangular regions REG1 and an associated shifted region REG1′. HAAR features of a rectangular region REG1 and a shifted rectangular region REG1 may, e.g., be used in object detection to improve the object detection performance. The shifted region REG1′ may for example be shifted relative to the rectangular region REG1 by a single pixel position along the row direction. In alternative examples, the shifted region may be shifted by a plurality of pixels, where the plurality is smaller than a width of an image block measured in the direction of the shift. The shifted region may alternatively correspond to a horizontal shift, a vertical shift, or a combination of a horizontal and a vertical shift such as a diagonal shift.

FIG. 9 schematically indicates a shifted rectangular region REG1′ that corresponds in size and shape to rectangular region REG1 but is horizontally shifted relative to the rectangular region REG1 (shown in dashed lines). Block-wise integral image values for the shifted rectangular region REG1′ use corresponding integral image reference signs as for REG1, but with a ‘-symbol appended to the reference sign. For calculating the HAAR feature of the shifted rectangular region REG1’, the main processor MCPU may thus calculate:

HAAR(REG1′)=IB1I4′−IB1I2′−IB1I3′+IB1I1′+IB2I4′−IB2I2′+IB3I4′−IB3I3″+IB4I4′

Herein, the bold-face printed integral image values, IB1I4′, IB1I2′, IB3I4′ correspond to the same pixel positions as the associated integral image value for rectangular region REG1. I.e., IB1I4′, IB1I2′, and IB3I4′ correspond to edge pixels of the respective rectangular regions in integral image blocks IB1, IB2, IB3 and IB4 along the row of the upper corner pixels P1, P2/P1′, P2′ and the row of the lower corner pixels P3, P4/P3′, P4′.

The main processor MCPU may be arranged to reuse the earlier retrieved integral image values IB1I4, IB1I2, IB3I4, as read from the one or more memories when calculating the HAAR feature of rectangular region REG1 when calculating the HAAR feature of the shifted rectangular region REG1′, i.e. as:

$$\begin{matrix}HAAR ( REG {1}^{′} ) == IB 1 I 4 - IB 1 I 2 - IB 1 I {3}^{′} + IB 1 I {1}^{′} + \\ IB 2 I {4}^{′} - IB 2 I {2}^{′} + IB 3 I 4 - IB 3 I {3}^{′} + \\ IB 4 I {4}^{′}\end{matrix}$$

The main processor MCPU may hereby reduce the number of values it has to read from memory from 9 to only 6, as the values IB1I4′, IB1I2′, and IB3I4′ along the vertical division between IB1 and IB2, and IB3 and IB4 do not need to be read again, as long as the corner pixels of the shifted region REG1′ and the rectangular region REG1 are in the same integral image block IB1, IB2, IB3 and IB4 resp. The same reduction of 3 may apply when shifting vertically as long as corner pixels P1′, P2′, P3′, P4′ of the shifted region REG1′ are in the same block as corner pixels P1, P2, P3, P4 of rectangular region REG1. If the shift is in a diagonal direction, a reduction of 1 may be achieved as long as corner pixels P1′, P2′, P3′, P4′ of the shifted region REG1′ are in the same block as corner pixels P1, P2, P3, P4 of rectangular region REG1, as the center values IB1I4′, does not need to be reread from the one or more memories MEM.

Thus, the main processor MCPU may be arranged to, for each block of image data IB1′, IB2′, IB3′, IB4′ that comprise pixels of the predefined rectangular region REG1′ of the image:
check whether integral image values (for example IB1I2′,IB1I4′, IB3I4′) of one or more of four corner pixels of the respective rectangular region part REC1′, REC2′, REC3′, REC4′ are already retrieved from the one or more memories MEM,
where integral image values are not yet retrieved for one or more of the four corner pixels of the respective rectangular region part REC1′, REC2′, REC3′, REC4′ from the one or more memories MEM, retrieve the block-wise integral image values (for example IB1I1′, IB1I3′) associated with the respective corner pixels (for example, B1C1, B1C3) of the respective rectangular region part REC1 from the one or more memories MEM,
where integral image values are already retrieved for one or more of the four corner pixels of the respective rectangular region part REC1′, REC2′, REC3′, REC4′ from the one or more memories MEM, use the block-wise integral image values (for example IB1I2, IB1I4, IB3I4) associated with the respective corner pixels (e.g., B1C2, B1C4 respectively) of the respective rectangular region part REC1 as already retrieved, and
calculate the HAAR feature of the rectangular region part, e.g. REC1′, for the block from the block-wise integral image values associated with the corner pixels (e.g., B1C1′, B1C2′, B1C3′, B1C4′) of the respective rectangular region part REC1′,
so as to calculate the HAAR features of the rectangular region parts REC1′, REC2′, REC3′, REC4′ for all blocks of image data that comprise pixels of the predefined rectangular region REG1′ of the image.

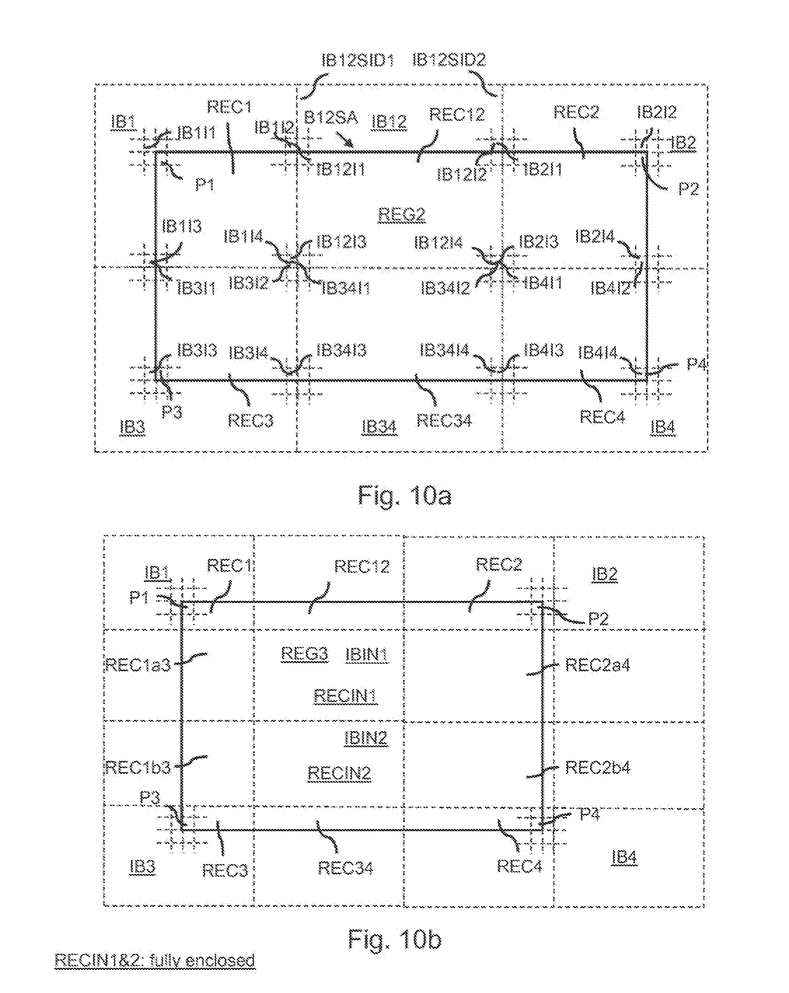

FIG. 10a and FIG. 10b schematically illustrates methods of calculating a HAAR feature according to further embodiments.

FIG. 10a illustrates a situation wherein a predetermined rectangular region REG2 does not extend over four image blocks, but over six pixel blocks along two block rows and three block columns. For handling such type of situations, the main processor MCPU may be arranged to detect that the predetermined rectangular region REG2 comprises edge rectangular regions REC12, REC34, positioned between the rectangular regions REC1, REC2, REC3 and REC4 that comprise the corner pixels P1, P2, P3, P4, and associated with integral image regions of blocks IB12 and IB34 in between IB1 and IB2 and IB3 and IB4 respectively.

In such type of situation, the main processor MCPU may calculate the HAAR feature of rectangular region REG2 from:

$$\begin{matrix}HAAR ( REG 2 ) = HAAR ( REC 1 ) + HAAR ( REC 12 ) + HAAR ( REC 2 ) + \\ HAAR ( REC 3 ) + HAAR ( REC 34 ) + HAAR ( REC 4 ) \\ = IB 1 I 4 - IB 1 I 2 - IB 1 I 3 + IB 1 I 1 + \\ IB 12 I 4 - IB 12 I 2 - IB 12 I 3 + IB 12 I 1 + \\ IB 2 I 4 - IB 2 I 2 - IB 2 I 3 + IB 2 I 1 + \\ IB 3 I 4 - IB 3 I 2 - IB 3 I 3 + IB 3 I 1 + \\ IB 34 I 4 - IB 34 I 2 - IB 34 I 3 + IB 34 I 1 + \\ IB 4 I 4 - IB 4 I 2 - IB 4 I 3 + IB 4 I 1 \\ = IB 1 I 4 - IB 1 I 2 - IB 1 I 3 + IB 1 I 1 + \\ IB 12 I 4 - IB 12 I 2 + IB 2 I 4 - IB 2 I 2 + \\ IB 3 I 4 - IB 3 I 3 + IB 34 I 4 + \\ IB 4 I 4 - IB 4 I 2 - IB 4 I 3 + IB 4 I 1 ,\end{matrix}$$

as IB12I3=0, IB12I1, IB2I3=0, IB2I1=0, IB3I2=0, IB3I1=0, IB34I2=0, IB34I3=0 and IB34I1=0. In the formula, the HAAR features and the block-wise integral image values printed in italic correspond to HAAR features and block-wise integral image values of the rectangular regions REC12, REC34 of side blocks IB12, IB34 and the other values correspond to those of the rectangular regions REC1, REC2, REC3, REC4 of corner blocks IB1, IB2, IB3, IB4. Herein, IBpq denotes the side block between IBp and IBq.

Hereto, the main processor may be further arranged to, in determining which one or more blocks of image data comprise pixels of the predefined rectangular region REG2 of the image, determine one or more side blocks (for example IB12, IB34) from identifying which one or more blocks of the one or more blocks of image data comprise an array (for example B12SA) of pixels extending from one side (such as IB12SID1 for array B12SA) of the block to an opposite side (such as IB12SID2 for array B12SA) of the block (such as block IB12 for array B12SA), the pixels of the array corresponding to side pixels of the predefined rectangular region REG2 of the image, wherein the side does not comprise one or more of the corner pixels P1, P2, P3, P4 of the predefined rectangular region REG2 of the image.

Further, the main processor may be arranged to, for each of the one or more side blocks (for example IB12, IB34), retrieve the integral image values (for example IB12, IB34) of corner pixels of the rectangular region part in the side block (such as IB12, IB34) from the one or more memories, and calculate the HAAR feature of the respective rectangular region part REC1 of the side block (for example, IB12, IB34) using the integral image values (for example, for IB12, IB12I1, IB12I2 and IB12I3, IB12I4) associated with the corner pixels of the rectangular region part in the side block (such as IB12, IB34).

FIG. 10b illustrates a situation wherein a predetermined rectangular region REG3 extends over twelve pixel blocks along four block rows and three block columns. The predetermined rectangular region REG3 thus corresponds to the total of the rectangular regions REC1, REC2, REC3, REC4 of corner blocks IB1, IB2, IB3, IB4, the rectangular regions REC12, REC34 of side blocks IB12, IB34, rectangular regions REC1a3, REC1b3 of side blocks between REC1 and REC3 at the left side of rectangular region REG3, rectangular regions REC2a4, REC2b4 of side blocks between REC2 and REC4 at the right side of rectangular region REG3, as well as enclosed rectangular regions RECIN1, RECIN2 with associated integral image blocks IBIN1, IBIN2. The enclosed rectangular regions RECIN1 and RECIN2 are fully contained in REG3 and may be referred to as enclosed rectangular regions or as contained rectangular regions.

The main processor MCPU may calculate the HAAR feature of rectangular region REG3 from

HAAR(REG3)=HAAR(REC1)+HAAR(REC12)+HAAR(REC2)+HAAR(REC1a3)+HAAR(RECIN1)+HAAR(REC2a4)+HAAR(REC1b3)+HAAR(RECIN2)+HAAR(REC2b4)+HAAR(REC3)+HAAR(REC34)+HAAR(REC4)

wherein HAAR features related with side regions are shown in normal face italic, and HAAR features associated with enclosed regions RECIN1 and RECIN2 are shown in boldface italic.

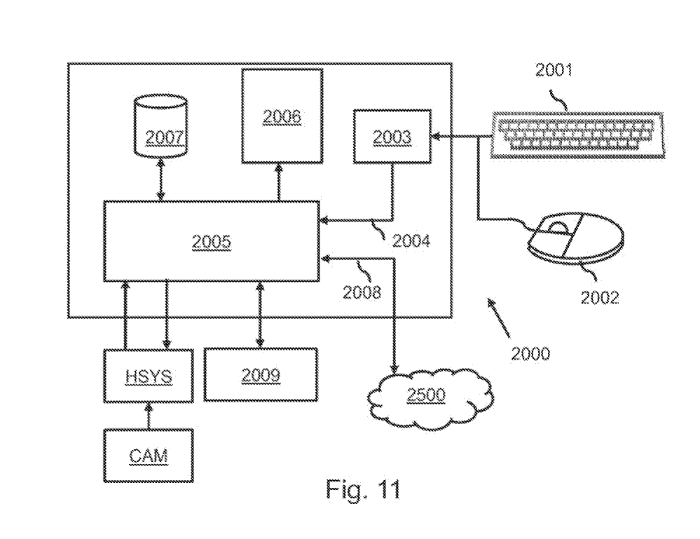

FIG. 11 schematically shows an exemplary user interaction system 2000 having a programmable processor 2005. The user interaction system 2000 is shown to be a personal computer, but may be any type of suitable user interaction system 2000. The programmable processor 2005 is arranged to be able to communicate with a HAAR calculation system HSYS as indicated. The HAAR calculation system HSYS may for example be according to an embodiment as described with reference to FIG. 1. The HAAR calculation system HSYS is capable to be connected to a camera CAM and to receive an image from the camera CAM via its camera interface CAM-IF (shown in FIG. 1). Alternatively may an image be provided to the HAAR calculation system HSYS by the programmable processor 2005 of the user interaction system 2000. The user interaction system 2000 further comprises a storage unit 2007, a user input 2003 and a display 2006. The user input 2003 allows the user to input user data and user instructions 2004 to the processor 2005 by e.g. using a keyboard 2001 or a mouse 2002. Also, although not shown, the display 2006 may comprise a touch-sensitive surface for enabling the user to provide user data and user instructions to the user input 2003 by means of touching the display 2006. The processor 2005 is arranged to perform any one of the methods according to the invention, to receive user data and user instructions 2004, to present visual information on the display 2006 and to communicate with a data I/O device 2009, such as an optical disc drive or a solid state reader/writer. The processor 2005 is arranged to cooperate with the storage unit 2007, allowing storing and retrieving information on the storage unit 2007. The user interaction system 2000 may further comprise a communication channel 2008 allowing the processor 2005 to connect to an external cloud 2500 for communicating with other devices in the cloud. The external cloud may e.g. be the Internet. The processor 2005 may also be arranged to retrieve information from the storage unit 2007, or from another device in the cloud 2500, such as an image received from a camera. The processor 2005 may be capable to read, using the data I/O device 2009, a computer readable medium comprising a computer program product comprising instructions for causing the HAAR calculation system HSYS to perform a method of calculating a HAAR feature according to an embodiment. The processor 2005 may further be may be capable to read, using the data I/O device 2009, a computer readable medium comprising a computer program product comprising instructions for causing the processor 2005 to perform a method of object detection and recognition using a HAAR feature as determined by the HAAR calculation system HSYS. In further embodiments, the programmable processor 2005 comprises the HAAR calculation system HSYS.

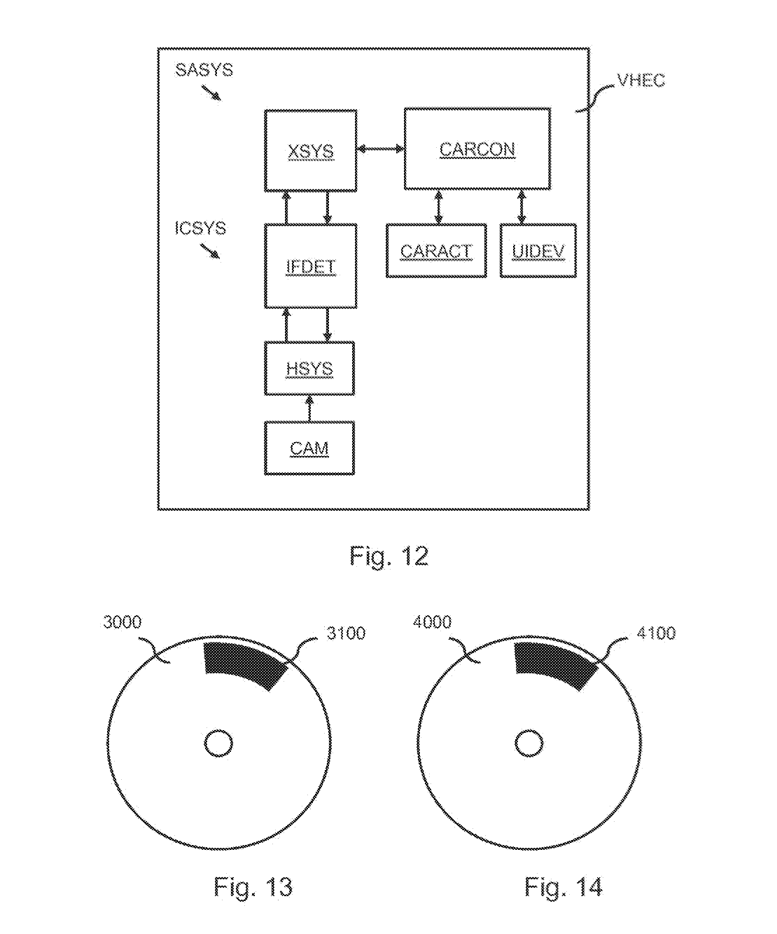

FIG. 12 schematically shows a vehicle VHEC comprising a safety system SASYS. The vehicle VHEC comprises a safety system SASYS arranged to detect safety-related risks and signal such risks to a driver of the vehicle or to emergency services and/or to signal to or control one or more vehicle actuators CARACT in response of a detected safety-related risk.

The safety system SASYS comprises an image classification system ICSYS and an expert system XSYS. The image classification system ICSYS comprising a HAAR calculation system HSYS according to an embodiment, an image source and an image feature detector. The image source may be a camera CAM as described with reference to FIG. 1 and indicated as such in FIG. 12, or another type of image generating unit, such as for example a radar detector. The HAAR calculation system HSYS is arranged to receive or retrieving an image IMG from the image source and to calculate one or more HAAR features of a predefined rectangular region REG1 of the image IMG. The image feature detector IFDET may be arranged to detect an image feature from comparing the one or more HAAR features with one or more predetermined reference values representative of the image feature, e.g., to detect edges in the image. The expert system XSYS is arranged to receive the image feature as detected by the image feature detector and to use the image feature to, at least one of detect an object, classify an object, recognize an object, detect and classify a road sign, detect and classify another vehicle, recognize a risk, recognize an immediate danger, perform pedestrian recognition, control the vehicle's driving, maintain a distance of the vehicle to a preceding vehicle within a predetermined distance range, and/or keep a position of the vehicle relative to a traffic lane within a predetermined lane keeping margin. The expert system XSYS may be arranged to provide information associated with a detected object, a classified object, a recognized risk, a recognized immediate danger, a positive pedestrian recognition, its control of the vehicle's driving, its maintaining of the distance of the vehicle to the preceding vehicle within the predetermined distance range, and/or its keeping of position of the vehicle relative to the traffic lane within the predetermined lane keeping margin to the driver from presenting the information to a user interaction device UIDEV, such as an electronic display, a visual indicator light, or an acoustic indicator. The expert system XSYS may be arranged to provide control information to a car control unit CARCON, such as control information associated controlling the vehicle's driving, such as control information to the break system for letting the vehicle stop in response of a detected immediate danger, its maintaining of the distance of the vehicle to the preceding vehicle within the predetermined distance range such as control information to a speed controller, and/or its keeping of position of the vehicle relative to the traffic lane within the predetermined lane keeping margin such as control information to a steering controller. The image feature detector IFDET, the expert system XSYS and the car control unit CARCON are an example of the host HOST shown in FIG. 1.

FIG. 13 shows a computer readable medium 3000 comprising a computer program product 3100. The computer program product 3100 comprises instructions for causing a processor apparatus comprising or cooperating with a of a HAAR calculation system HSYS having a plurality of compute engines CU1, CU2, CU3, CUn and a main processor MCPU to perform a method of calculating a HAAR feature according to an embodiment. The computer program product 3100 may be embodied on the computer readable medium 3000 as physical marks or by means of magnetization of the computer readable medium 3000. However, any other suitable embodiment is conceivable as well. Furthermore, it will be appreciated that, although the computer readable medium 3000 is shown in FIG. 13 as an optical disc, the computer readable medium 3000 may be any suitable computer readable medium, such as a hard disk, solid state memory, flash memory, etc., and may be non-recordable or recordable. The computer program product 3100 comprises instructions for causing a processor system having a plurality of compute engines to perform a method of calculating a HAAR feature.

The computer program product 3100 may comprise instructions for causing each of the plurality of compute engines CU1, CU2, CU3, CUn repeatedly a1) retrieve a block of image data BLK(i) corresponding to a rectangular image region BLK(1) . . . (BLK(mn+n) from one or more memories MEM, a2) calculate integral image values IBLK(i) for all pixels of the block of image data to obtain an integral image of the block of image data, and a3) store the integral image IBLK(i) of the block in the one or more memories MEM, and for causing the main processor MCPU to: b1) determine which one or more blocks of image data comprise pixels of the predefined rectangular region of the image, b2) for each block of image data that comprise pixels of the predefined rectangular region of the image, define a respective rectangular region part REC1, REC2, REC3, REC4, REC12, REC34 as the pixels of the block that belong to the predefined rectangular region of the image, b3) calculate a HAAR feature of the rectangular region part REC1, REC2, REC3, REC4, REC12, REC34 for each block of image data IB1, IB2, IB3, IB4, IB12, IB34 that comprise pixels of the predefined rectangular region REG1 of the image, and b4) add the HAAR features of the rectangular region parts REC1, REC2, REC3, REC4, REC12, REC34 to obtain the HAAR feature of the predefined rectangular region of the image.

FIG. 14 shows another computer readable medium 4000 comprising another computer program product 4100. The computer program product 4100 comprises instructions for causing a compute engine of a HAAR calculation system HSYS comprising a plurality of compute engines of a massive parallel processor to perform a method of calculating an integral image value of a block of image data of a plurality of blocks of image data of an image, the method comprising repeatedly: retrieving a block of image data BLK(i) corresponding to a rectangular image region BLK(1) . . . (BLK(mn+n) from one or more memories MEM, calculating integral image values IBLK(i) for all pixels of the block of image data to obtain an integral image of the block of image data, and storing the integral image IBLK(i) of the block in the one or more memories MEM. Hereby, a plurality of compute engine of the plurality of compute engines of the massive parallel processor may be arranged to calculate a plurality of integral images of one or more block of image data. The computer program product 4100 may be embodied on the computer readable medium 4000 as physical marks or by means of magnetization of the computer readable medium 4000. However, any other suitable embodiment is conceivable as well. Furthermore, it will be appreciated that, although the computer readable medium 4000 is shown in FIG. 14 as an optical disc, the computer readable medium 4000 may be any suitable computer readable medium, such as a hard disk, solid state memory, flash memory, etc., and may be non-recordable or recordable. The computer program product 4100 comprises instructions for causing one or more compute engines of a massive parallel processor to perform a method of calculating an integral image value of a block of image data of a plurality of blocks of image data of an image.

In another embodiment, the computer program product comprises instructions for causing a main processor MCPU of a HAAR calculation system HSYS to: b1) determine which one or more blocks of image data comprise pixels of the predefined rectangular region of the image, b2) for each block of image data that comprise pixels of the predefined rectangular region of the image, define a respective rectangular region part REC1, REC2, REC3, REC4, REC12, REC34 as the pixels of the block that belong to the predefined rectangular region of the image, b3) calculate a HAAR feature of the rectangular region part REC1, REC2, REC3, REC4, REC12, REC34 for each block of image data IB1, IB2, IB3, IB4, IB12, IB34 that comprise pixels of the predefined rectangular region REG1 of the image, and b4) add the HAAR features of the rectangular region parts REC1, REC2, REC3, REC4, REC12, REC34 to obtain the HAAR feature of the predefined rectangular region of the image.

An operating system (OS) is the software that manages the sharing of the resources of a computer and provides programmers with an interface used to access those resources. An operating system processes system data and user input, and responds by allocating and managing tasks and internal system resources as a service to users and programs of the system.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may further be a data connection, such as a telephone cable or a wireless connection.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of system HSYS are circuitry located on a single integrated circuit or within a same device. Alternatively, system HSYS may include any number of separate integrated circuits or separate devices interconnected with each other. For example, main processor MCPU may be located on a same integrated circuit as compute engines CU1, CU2, . . . , CUn or on a separate integrated circuit or located within another peripheral or slave discretely separate from other elements of system HSYS. Peripherals such as camera CAM and I/O circuitry such as camera interface CAM-IF may also be located on separate integrated circuits or devices. Also for example, system HSYS or portions thereof may be soft or code representations of physical circuitry or of logical representations convertible into physical circuitry. As such, system HSYS may be embodied in a hardware description language of any appropriate type. Also for example, one or more compute engines of the plurality of compute engines CU1, CU2, CU3, . . . CUn may be arranged to perform some of the tasks of the main processor MCPU and/or act as the main processor MCPU. Also for example, the main processor MCPU may be arranged to execute part of its tasks on one or more compute engines of the plurality of compute engines CU1, CU2, CU3, . . . CUn.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein may be received elements of system HSYS, for example, from computer readable media such as memory MEM or other media on other computer systems. Such computer readable media may be permanently, removably or remotely coupled to an information processing system such as system HSYS or user interaction system 2000. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

In one embodiment, system HSYS is a computer system such as a personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

A computer system processes information according to a program and produces resultant output information via I/O devices. A program is a list of instructions such as a particular application program and/or an operating system. A computer program is typically stored internally on computer readable storage medium or transmitted to the computer system via a computer readable transmission medium. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device. Also, devices functionally forming separate devices may be integrated in a single physical device. Also, the units and circuits may be suitably combined in one or more semiconductor devices.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A HAAR calculation system for calculating a HAAR feature of a predefined rectangular region of an image, the HAAR calculation system comprising:
one or more memories for storing data including an image data,
a plurality of compute engines, each of the compute engines being arranged to repeatedly:
retrieve a block of image data corresponding to a rectangular image region from the one or more memories,
calculate integral image values for all pixels of the block of image data to obtain an integral image of the block of image data, and
store the integral image of the block in the one or more memories;
a main processor arranged to:
determine which one or more blocks of image data comprise pixels of the predefined rectangular region of the image,
for each block of image data that comprise pixels of the predefined rectangular region of the image, define a respective rectangular region part as the pixels of the block that belong to the predefined rectangular region of the image,
calculate a HAAR feature of the rectangular region part for each block of image data that comprise pixels of the predefined rectangular region of the image, and
add the HAAR features of the rectangular region parts to obtain the HAAR feature of the predefined rectangular region of the image.

2. A HAAR calculation system according to claim 1, the main processor being arranged to, for each block of image data that comprise pixels of the predefined rectangular region of the image:
retrieve integral image values associated with the corner pixels of the respective rectangular region part from the one or more memories, and
calculate the HAAR feature of the rectangular region part for the block from the integral image values associated with the corner pixels of the respective rectangular region part,
so as to calculate the HAAR features of the rectangular region parts for all blocks of image data that comprise pixels of the predefined rectangular region of the image.

3. A HAAR calculation system according to claim 1, the main processor being arranged to, for each block of image data that comprise pixels of the predefined rectangular region of the image:
check whether integral image values associated with the one or more of four corner pixels of the respective rectangular region part are already retrieved from the one or more memories,
where integral image values are not yet retrieved for one or more of the four corner pixels of the respective rectangular region part from the one or more memories, retrieve the integral image values associated with the respective corner pixels of the respective rectangular region part from the one or more memories,
where integral image values are already retrieved for one or more of the four corner pixels of the respective rectangular region part from the one or more memories, use the integral image values associated with the respective corner pixels of the respective rectangular region part as already retrieved, and
calculate the HAAR feature of the rectangular region part for the block from the integral image values associated with the corner pixels of the respective rectangular region part,
so as to calculate the HAAR features of the rectangular region parts for all blocks of image data that comprise pixels of the predefined rectangular region of the image.

4. A HAAR calculation system according to claim 1, the main processor being arranged to, in determining which one or more blocks of image data comprise pixels of the predefined rectangular region of the image:
determine one or more corner blocks from identifying which one or more blocks of the one or more blocks of image data comprise a corner pixel of the predefined rectangular region of the image.

5. A HAAR calculation system according to claim 4, the main processor being arranged to, for each of the one or more corner blocks:
retrieve the integral image values associated with corner pixels of the rectangular region part in the corner block from the one or more memories, and
calculate the HAAR feature of the rectangular region part of the corner block using the integral image values associated with the corner pixels of the rectangular region part in the corner block.

6. A HAAR calculation system according to claim 4, the main processor being further arranged to, in determining which one or more blocks of image data comprise pixels of the predefined rectangular region of the image:
determine one or more side blocks from identifying which one or more blocks of the one or more blocks of image data comprise an array of pixels extending from one side of the block to an opposite side of the block, the pixels of the array corresponding to side pixels of the predefined rectangular region of the image, wherein the side does not comprise one or more of the corner pixels of the predefined rectangular region of the image.

7. A HAAR calculation system according to claim 6, the main processor being arranged to, for each of the one or more side blocks:
retrieve the integral image values associated with corner pixels of the rectangular region part in the side block from the one or more memories, and
calculate the HAAR feature of the rectangular region part of the side block using the integral image values associated with the corner pixels of the rectangular region part in the side block.

8. A HAAR calculation system according to claim 1, the plurality of compute engines comprising at least 16 compute engines, such as 32, 64 of 128 compute engines.

9. A HAAR calculation system according to claim 1, the plurality of compute engines being arranged to be executed with a common program.

10. A HAAR calculation system according to claim 1, each compute engine of the plurality of compute engines being a vector processor, arranged to simultaneously process a plurality of pixels.

11. A HAAR calculation system according to claim 1, the image data being represented with a pixel bit depth and the compute engines being arranged to calculate the integral image values at a bit depth in a range of 1.5-3 times the pixel bit depth, such as 2 times the pixel bit depth.

12. A HAAR calculation system according to claim 1, the one or more memories comprising at least a DDR memory.

13. A HAAR calculation system according to claim 1 further comprising, an image source and an image feature detector,
the HAAR calculation system being arranged to receive or retrieve the image from the image source and to calculate one or more HAAR features of a predefined rectangular region of the image, and
the image feature detector being arranged to detect an image feature from comparing the one or more HAAR features with one or more predetermined reference values representative of the image feature.

14. A HAAR calculation system according to claim 13 in a safety system, the safety system including an expert system, the expert system being arranged to receive the image feature as detected by the image feature detector and to use the image feature to, at least one of:
detect an object,
classify an object,
recognize an object,
detect and classify a road sign,
detect and classify another vehicle,
recognize a risk,
recognize an immediate danger,
perform pedestrian recognition,
control the vehicle's driving,
maintain a distance of the vehicle to a preceding vehicle within a predetermined distance range, and/or
keep a position of the vehicle relative to a traffic lane within a predetermined lane keeping margin.

15. A method of detecting an image feature in an image, the method comprising:
by a plurality of compute engines, the plurality of compute engines being capable of accessing one or more memories for at least reading image data stored in the one or more memories from the one or more memories and storing data in the one or more memories, repeatedly:
retrieving a block of image data corresponding to a rectangular image region from the one or more memories,
calculating integral image values for all pixels of the block of image data to obtain an integral image of the block of image data, and
storing the integral image of the block in the one or more memories;
by a main processor:
determining which one or more blocks of image data comprise pixels of the predefined rectangular region of the image,
for each block of image data that comprise pixels of the predefined rectangular region of the image, defining a respective rectangular region part as the pixels of the block that belong to the predefined rectangular region of the image,
calculating a HAAR feature of the rectangular region part for each block of image data that comprise pixels of the predefined rectangular region of the image, and
adding the HAAR features of the rectangular region parts to obtain the HAAR feature of the predefined rectangular region of the image.

16. (canceled)

17. A method detecting an image feature in an image according to claim 16, further comprising:
detecting an object,
classifying an object,
recognizing an object,
detecting and classifying a road sign,
detecting and classifying another vehicle,
recognizing a risk,
recognizing an immediate danger,
performing pedestrian recognition,
controlling a vehicle's driving,
maintaining a distance of the vehicle to a preceding vehicle within a predetermined distance range, and/or
keeping a position of the vehicle relative to a traffic lane within a predetermined lane keeping margin.

18. (canceled)

19. (canceled)

20. (canceled)
